(19) United States
(12) Patent Application Publication
(10) Pub. No.: US 2013/0089301 A1
(43) Pub. Date: Apr. 11, 2013

(54) METHOD AND APPARATUS FOR PROCESSING VIDEO FRAMES IMAGE WITH IMAGE REGISTRATION INFORMATION INVOLVED THEREIN

(71) Applicants: Chi-Cheng Ju, Hsinchu City (TW); Ding-Yun Chen, Taipei City (TW); Cheng-Tsai Ho, Taichung City (TW)

(72) Inventors: Chi-Cheng Ju, Hsinchu City (TW); Ding-Yun Chen, Taipei City (TW); Cheng-Tsai Ho, Taichung City (TW)

(21) Appl. No.: 13/484,276

(22) Filed: May 31, 2012

Related U.S. Application Data
(60) Provisional application No. 61/543,906, filed on Oct. 6, 2011.
(60) Provisional application No. 61/560,411, filed on Nov. 16, 2011.

(51) Int. Cl. H04N 7/00; H04N 5/93

(52) U.S. Cl. 386/241; 348/36; 386/E05.028; 348/E07.001

(57) ABSTRACT

A method of processing a plurality of video frames includes: obtaining image registration information of the video frames, wherein the image registration information is used to transform different video frames into one coordinate system; and searching for a plurality of target video frames corresponding to a selected scene among the video frames by using the image registration information. A playback method of a video stream includes: receiving a playback request for a selected scene; searching the video stream for target video frames corresponding to image registration information of the selected scene, wherein the image registration information is used to transform different video frames into one coordinate system; and performing a playback operation according to the target video frames found in the video stream.

### CROSS REFERENCE TO RELATED APPLICATIONS

This application claims the benefit of U.S. provisional application No. 61/543,906 (filed on Oct. 06, 2011) and U.S. provisional application No. 61/560,411 (filed on Nov. 16, 2011). The entire contents of these related applications are incorporated herein by reference.

### BACKGROUND

The disclosed embodiments of the present invention relate to processing video frames, and more particularly, to a method and apparatus for processing video frames with image registration information involved therein.

A panoramic video is a video made up of a sequence of panoramic video frames depicting a surrounding scene. Hence, when the panoramic video is displayed on a display apparatus, a viewer is capable of having a 360-degree view of the surrounding scene. Creating panoramic video content is not straightforward for general users. A number of different systems for generating panoramic videos have been developed. For example, the conventional approaches to create panoramic video can be divided into four categories, including specialized optical devices, synchronized cameras, panoramic video textures, and foreground and background segmentation. However, each of the conventional approaches has certain drawbacks in actual implementation. The approach of specialized optical devices will restrict the video resolution of the captured scenes. The approach of synchronized cameras requires many cameras, and is unreachable for normal use condition. The approach of panoramic video textures requires huge computation of graph cut algorithm, and generates artifacts in complex moving object scenes. The approach of foreground and background segmentation requires a very good object segmentation and tracking, which is still an open, difficult problem now even using stereo cameras. Besides the approach of specialized optical devices, other approaches need to stitch multiple video segments together.

Moreover, stitching is the major reason to produce ghosting or artifact. There is no existing ideal algorithm to analysis and stitch without ghosting for a wide range of various scenes. In addition, all conventional panoramic viewing systems require cropping and warping the video frame to display the correct perspective view. The warping algorithm requires high computation and is time consuming for displaying each video frame especially in a low cost hand-held device.

Thus, there is a need for an innovative design which can simply and efficiently create and display a panoramic video.

### SUMMARY

In accordance with exemplary embodiments of the present invention, a method and apparatus for processing video frames with image registration information involved therein are proposed to solve the above-mentioned problems.

According to a first aspect of the present invention, an exemplary method of processing a plurality of video frames is disclosed. The exemplary method includes: obtaining image registration information of the video frames, wherein the image registration information is used to transform different video frames into one coordinate system; and searching for a plurality of target video frames corresponding to a selected scene among the video frames by using the image registration information.

According to a second aspect of the present invention, an exemplary playback method of a video stream is disclosed. The exemplary playback method includes: receiving a playback request for a selected scene; searching the video stream for target video frames corresponding to image registration information of the selected scene, wherein the image registration information is used to transform different video frames into one coordinate system; and performing a playback operation according to the target video frames found in the video stream.

According to a third aspect of the present invention, an exemplary apparatus for recording a plurality of video frames is disclosed. The exemplary apparatus includes a video processing circuit and an information acquisition circuit. The video processing circuit is arranged for generating a video stream according to the video frames. The information acquisition circuit is arranged for obtaining image registration information of the video frames, and recording the image registration information in the video stream, wherein the image registration information is used to transform different video frames into one coordinate system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a recording apparatus according to an exemplary embodiment of the present invention.

FIG. 2 is a diagram illustrating a recording apparatus according to another exemplary embodiment of the present invention.

FIG. 3 is a diagram illustrating an alternative design of the recording apparatus shown in FIG. 1.

FIG. 4 is a diagram illustrating an alternative design of the recording apparatus shown in FIG. 2.

FIG. 5 is a diagram illustrating an exemplary arrangement of the video frames to be processed by the recording apparatus.

FIG. 6 is a diagram illustrating another exemplary arrangement of the video frames to be processed by the recording apparatus.

FIG. 7 is a flowchart illustrating a method for recording a plurality of video frames according to an exemplary embodiment.

FIG. 8 is a diagram illustrating a playback apparatus according to an exemplary embodiment of the present invention.

FIG. 9 is a diagram illustrating an exemplary video frame selection based on the playback request.

FIG. 10 is a diagram illustrating another exemplary video frame selection based on the playback request.

FIG. 11 is a diagram illustrating yet another exemplary video frame selection based on the playback request.

FIG. 12 is a diagram illustrating an example of the viewing frame size normalization.

FIG. 13 is a diagram illustrating an example of the frame alignment process.

FIG. 14 is a flowchart illustrating a playback method of a video stream according to an exemplary embodiment.

FIG. 15 is a diagram illustrating a playback apparatus according to another exemplary embodiment of the present invention.

FIG. 16 is a flowchart illustrating a playback method of a video stream according to another exemplary embodiment.

FIG. 17 is a diagram illustrating one live wallpaper displayed in a display screen of an electronic device.

FIG. 18 is a diagram illustrating another live wallpaper displayed in the display screen due to a desktop scrolling command.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The main concept of the present invention is to index each video frame of a video stream by image registration information, search for a plurality of target video frames corresponding to a selected scene by using the image registration information, and performing a playback operation according to the found target video frames. In this way, the overlapped region of consecutive video frames for a selected viewing angle is displayed. Besides, the image registration results of video frames are applied to interactive navigation and video stabilization rather than stitching. The cropping operation likes the video stabilization, so that the video sequence in the same viewing angle can be stably displayed without global motion. The proposed panoramic video system is capable of selecting video frames according to user's viewing angle, and cropping the video frames according to the image registration results without image warping. As image stitching and warping operations are not required, the output video quality of the proposed panoramic display approach is guaranteed without any ghosting and image distortion present in the conventional panoramic display approaches. The output resolution of each video frame is also high, and is close to original captured resolution. Unlike conventional stitched algorithms which only support limited scenes without complex moving object, the proposed panoramic video system can support a wide range of various scenes. Besides, compared to the conventional approaches, the proposed approach has lower system requirement due to the fact that no specialized hardware or multiple cameras are used. Hence, the general user can use the proposed panoramic video system to create and navigate the panoramic video much more easily. In addition, the video registration pre-processing is also simple with low computational complexity as no graph cut algorithm with high computational complexity is employed. The proposed panoramic video system has low computational complexity by only selecting and cropping video frames without complex warping operation. Thus, the proposed panoramic video system is also suitable for low cost hand-held devices. Although without generating a real wide-field panoramic video frame, the user could still have the same user experience when interactive with the panoramic display device/system.

The proposed panoramic video system may include a video recording stage and a video viewing stage. Further details of the technical features of the present invention are described as below.

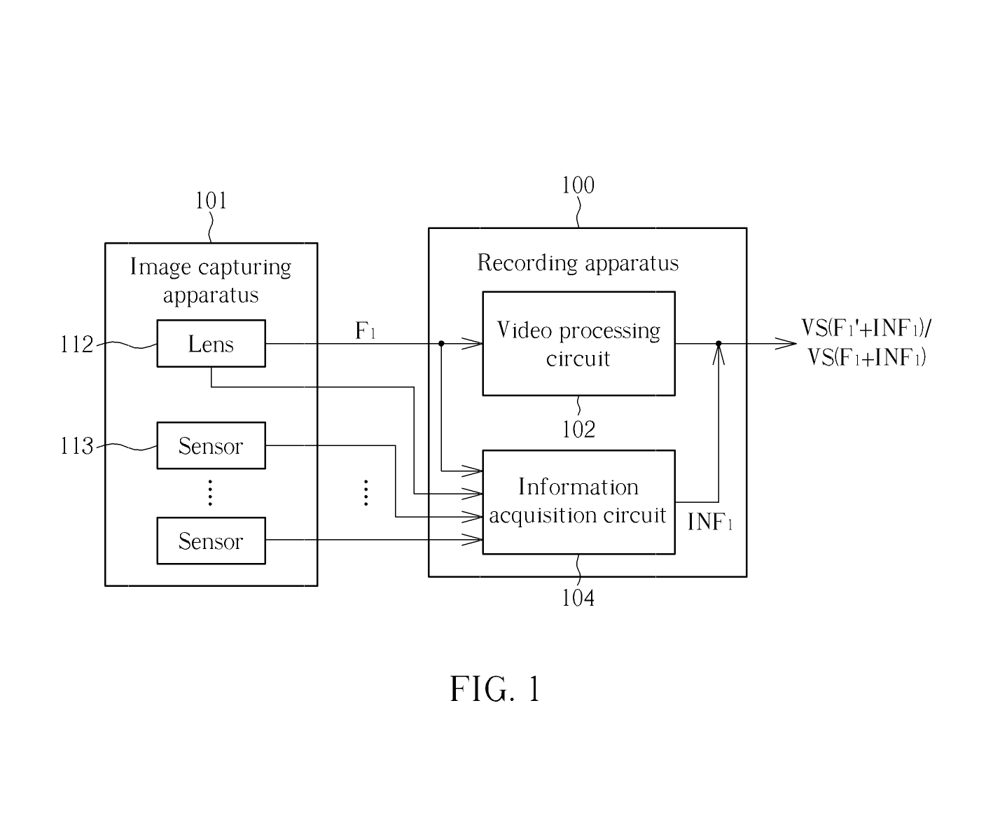

FIG. 1 is a diagram illustrating a recording apparatus according to an exemplary embodiment of the present invention. The exemplary recording apparatus 100 includes, but is not limited to, a video processing circuit 102 and an information acquisition circuit 104. In addition, the video processing circuit 102 is coupled to an image capturing apparatus 101 having a single lens 112 and a plurality of sensors 113. By way of example, the sensors 113 may include an orientation sensor, a multiple-axis accelerometer, a temperature sensor, a magnetic sensor, a light sensor, and a proximity sensor. It should be noted that the number and types of sensors implemented in the image capturing apparatus 101 are for illustrative purposes only, and are not meant to be limitations of the present invention. The image capturing apparatus 101 may be disposed in a hand-held device such as a digital camera or a mobile phone, and is used to capture video frames F₁ using the single lens 112. For example, the user may move/pan the image capturing apparatus 101 in a desired direction (e.g., from left to right horizontally) or rotate the image capturing apparatus 101 in a desired direction (e.g., clockwise or counterclockwise) to capture the video frames F sequentially. For example, the image capturing apparatus 101 may be rotated to capture video frames of a surrounding scene of the image capturing apparatus 101, or may be rotated with respect to a target object to capture video frames of a surrounding view of the same target object. The video processing circuit 102 is arranged for generating a video stream VS according to the video frames F₁. In one implementation, the video processing circuit 102 may be a video encoder used for encoding the video frames F₁ as the video stream VS including encoded video frames F₁′. In another implementation, the video processing circuit 102 may sequentially output the received raw image data as the video stream VS including the video frames F₁. In other words, no compression/encoding is applied to the video frames F₁.

The information acquisition circuit 104 is a pre-processing circuit arranged for obtaining image registration information INF₁ of the video frames F₁, and recording the image registration information INF₁ in the video stream VS. In this embodiment, the image registration information INF₁ may be used to transform different video frames into one coordinate system. The information acquisition circuit 104 may employ one or more of the following exemplary information acquisition designs for obtaining the desired image registration information INF, of the video frames F₁.

Regarding a first exemplary information acquisition design, the information acquisition circuit 104 may be configured to assign a scene number to each of the video frames F₁ to thereby obtain the image registration information INF₁. By way of example, but not limitation, video frames captured under the same viewing angle (e.g., recorded video frames that contain common object(s) in a physical environment) may be assigned by the same scene number. In other words, the image registration information of each video frame would record the scene number of the video frame. It should be noted that each selectable scene within the panoramic video would have a unique scene number.

Regarding a second exemplary information acquisition design, the information acquisition circuit 104 may be configured to assign a coordinate to each of the video frames F₁ to thereby obtain the desired image registration information INF₁ of the video frames F₁. In other words, the image registration information of each video frame would record the coordinate of the video frame. For example, a coordinate assigned to a beginning video frame of an initially captured scene among the video frames F₁ is at an origin. Hence, regarding the following video frames corresponding to captured scenes that are deviated from the initially captured scene, the image registration information of the following video frames would record coordinates different from the coordinate of the origin. Besides, based on the actual design consideration/requirement, the coordinate assigned to each video frame may define a location in a one-dimensional coordinate system, a two-dimensional coordinate system, a three-dimensional coordinate system, or a coordinate system with more dimensions. By way of example, but not limitation, the video registration pre-processing operation performed by the information acquisition circuit 104 may align video frames into a 2D space by using the following cost function with minimized sum of squared intensity error between two video frames:

E=Σ[I₁′(x′, y′)−I₀(x, y)]² (1)

where I₀(x, y) and I₁′(x′, y′) are corresponding pairs of overlapped pixels between video frames I₀ and I₁′, where the video frame I₁′ is a transformation from a video frame I₁. The video frame alignment process is to find a transformation with the minimal error from a set of different transformation. For global image registration, the transformation can be from 2D translation by hierarchical matching. So, the 2D translation may be simply used by the proposed panoramic video system to align the video frames. It should be noted that the above is for illustrative purposes only, and is not meant to be a limitation of the present invention. Using other approach to assign a coordinate value as the image registration information of each video frame is also feasible.

Regarding a third exemplary information acquisition design, the information acquisition circuit 104 may be configured to apply a global motion estimation upon every adjacent video frames of the video frames F₁ and accordingly generate corresponding global motion information, thereby obtaining the image registration information INF₁. In other words, the image registration information of each video frame would record the global motion information of the video frame.

Regarding a fourth exemplary information acquisition design, the information acquisition circuit 104 may be configured to obtain sensor information provided by at least one of the sensors 113 disposed on the image capturing apparatus 101 that generates the video frames F₁, thereby obtaining the desired image registration information INF₁. In other words, the image registration information of each video frame would record the sensor information of the video frame. Hence, the sensor information including one or more sensor values provided by the sensors 113 would indicate the status of the image capturing apparatus 101 while the video frame is being captured by the image capturing apparatus 101. Taking the sensor information as the image registration information can reduce the computational complexity. Besides, the sensor information is helpful especially for the case when most regions of video frames are occluded by a fast moving object.

Regarding a fifth exemplary information acquisition design, the information acquisition circuit 104 may be configured to obtain at least one of translate information, rotation information, and scale information of each of the video frames F₁ to thereby obtain the image registration information INF₁. Hence, the image registration information of each video frame would indicate the image processing status associated with the generation of the video frame.

Regarding a sixth exemplary information acquisition design, the information acquisition circuit 104 may be configured to obtain camera capture condition information of each of the video frames F₁ to thereby obtain the image registration information INF₁. For example, the camera capture condition information of each video frame would record at least one of focus information, white balance information, and expose information while the video frame is being captured by the image capturing apparatus 101.

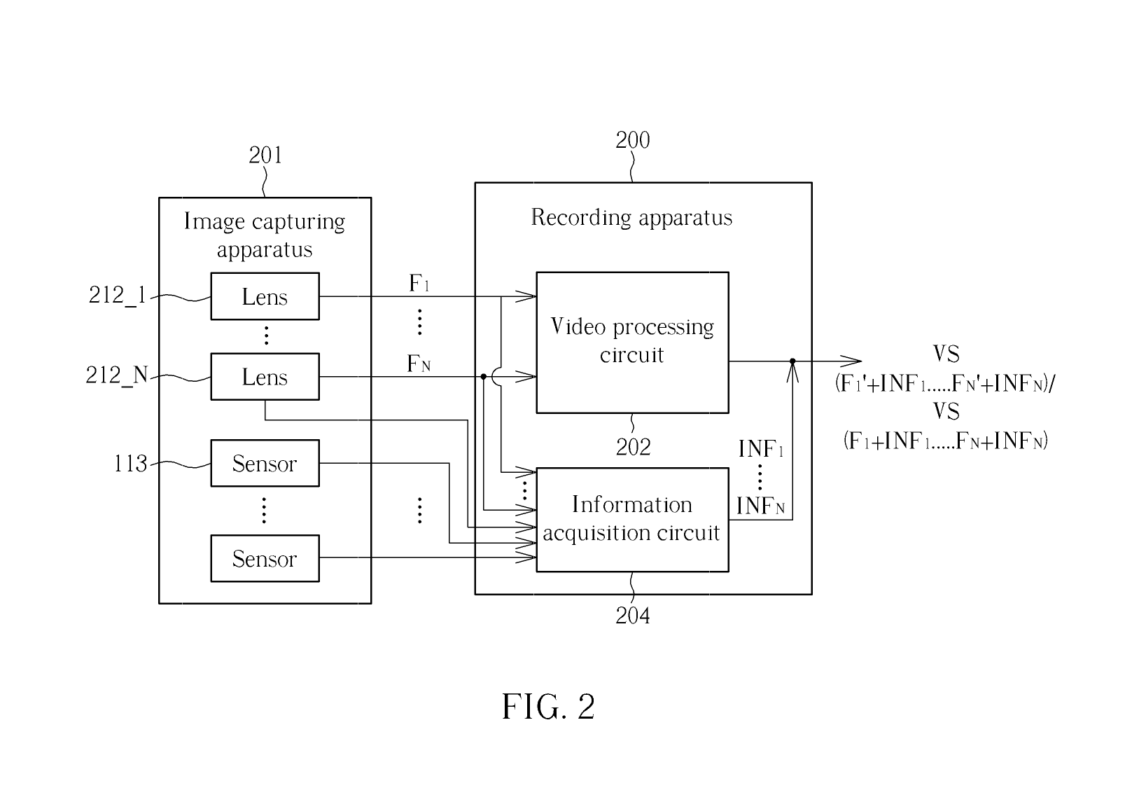

The recording apparatus of the present invention may also be employed for processing video frames generated from an image capturing apparatus with multiple lenses. FIG. 2 is a diagram illustrating a recording apparatus according to another exemplary embodiment of the present invention. As shown in the figure, the image capturing apparatus 201 has a plurality of lenses 212_1-212_N for generating video frames F₁-F_{N}, respectively. Regarding the processing of the video frames captured via each lens, operations of the video processing circuit 202 and information acquisition circuit 204 in the recording apparatus 200 are identical to that of the video processing circuit 102 and information acquisition circuit 104. Therefore, image registration information INF₁ is recorded for the video frames F₁ generated from the lens 212_1, and image registration information INF_{N} is recorded for the video frames F_{N} generated from the lens 212_N. Hence, in a case where the video processing circuit 202 is implemented using a video encoder, the video stream VS would include encoded video frames F₁′-F_{N}′ and associated image registration information INF₁-INF_{N} of the video frames F₁-F_{N}. However, in another case where the video processing circuit 202 does not apply compression/encoding to the video frames F₁-F_{N}, the video stream VS would include raw image data (i.e., video frames F₁-F_{N}) and associated image registration information INF₁-INF_{N}.

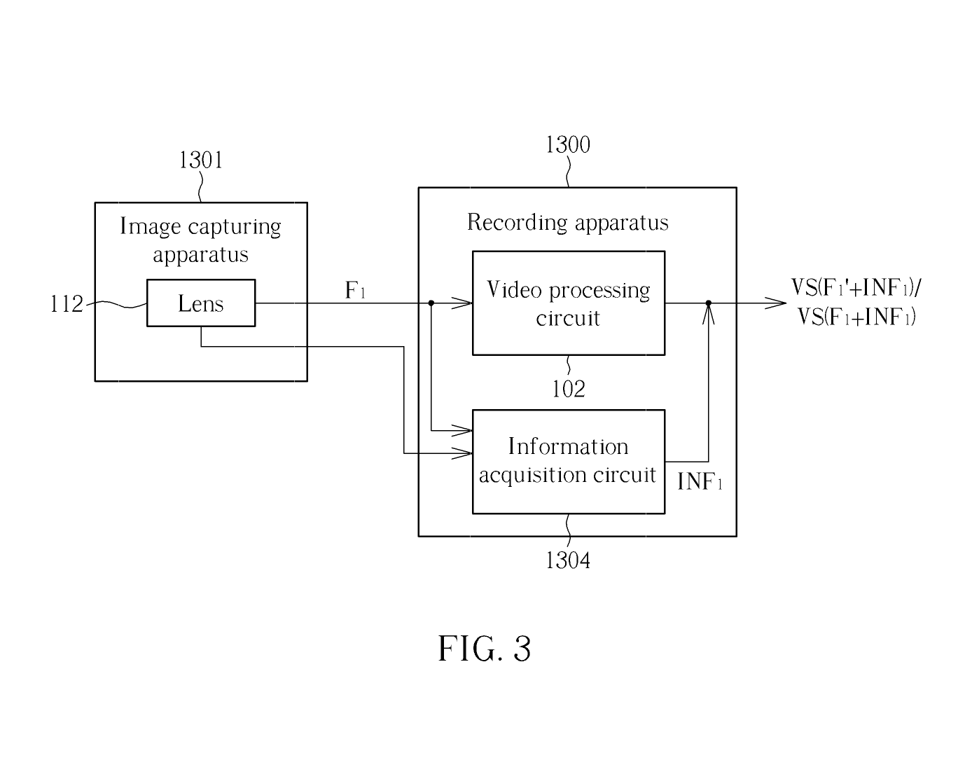

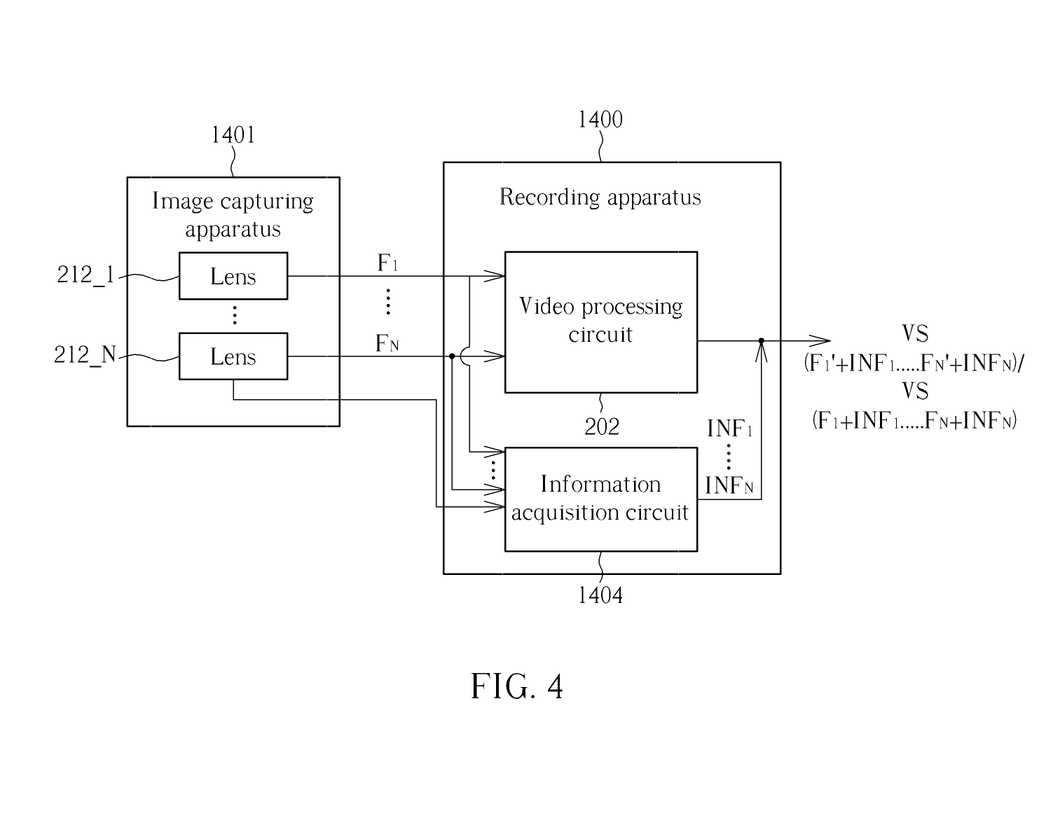

As mentioned above, the desired image registration information may be obtained by refereeing to the sensor information. However, this is not meant to be a limitation of the present invention. FIG. 3 is a diagram illustrating an alternative design of the recording apparatus shown in FIG. 1. As shown in FIG. 3, the image capturing apparatus 1301 does not have any sensor 113 included therein. However, the information acquisition circuit 1304 may still obtain the desired image registration information INF₁ by employing one of the aforementioned first, second, third, fifth, and sixth exemplary information acquisition designs. FIG. 4 is a diagram illustrating an alternative design of the recording apparatus shown in FIG. 2. As shown in FIG. 4, the image capturing apparatus 1401 does not have any sensor 113 included therein. However, the information acquisition circuit 1404 may still obtain the desired image registration information INF₁-INF_{N} by employing one of the aforementioned first, second, third, fifth, and sixth exemplary information acquisition designs.

Regarding the recording apparatus 100/200/1300/1400 shown in FIG. 1/FIG. 2/FIG. 3/FIG. 4, the video frames F₁/F₁-F_{N} received by the recording apparatus 100/200/1300/1400 are directly generated from the image capturing apparatus 101/201/1301/1401. However, this is for illustrative purposes only, and is not meant to be a limitation of the present invention. That is, the present invention has no limitation on the source of the video frames to be processed by the recording apparatus 100/200/1300/1400. Taking the video frames F₁ fed into the recording apparatus 100/1300 for example, the video frames F₁ may be derived from one video clip which is manually edited by the user.

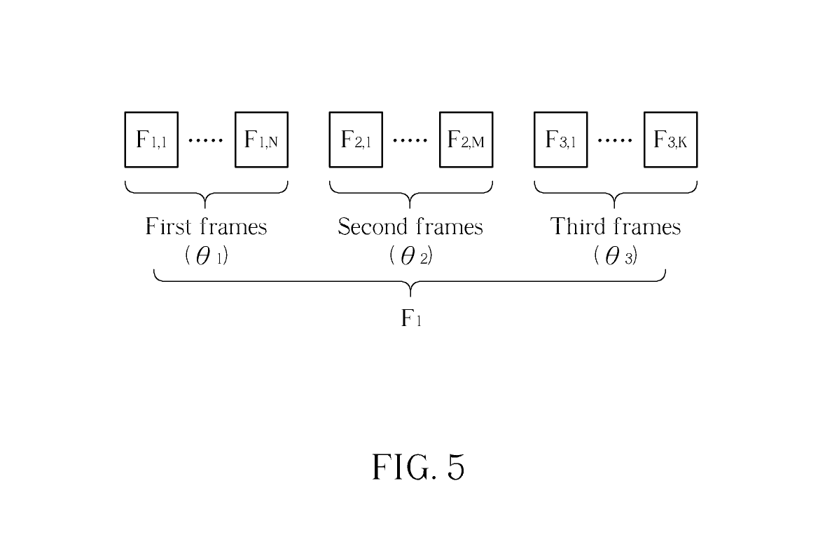

In one alternative design, the video frames F₁ may be derived from a plurality of video clips captured at different viewing angles. Please refer to FIG. 5, which is a diagram illustrating an exemplary arrangement of the video frames F₁ to be processed by the recording apparatus 100/1300. As shown in FIG. 5, the video frames F₁ at least include first video frames F_{1,1}-F_{1,N}, second video frames F_{2,1}-F_{2,M}, and third video frames F_{3,1}-F_{3,K}. The image capturing apparatus 101/1301 is properly moved/rotated such that all of the first video frames F_{1,1}-F_{1,N} are generated by the lens 112 at the same viewing angle θ₁ (e.g., θ₁=0°), all of the second video frames F_{2,1}-F_{2,M} are generated by the lens 112 at the same viewing angle θ₂ (e.g., θ₂=5°), and all of the third video frames F_{3,1}-F_{3,K} are generated by the lens 112 at the same viewing angle θ₃ (e.g., θ₃10°). The video frames F_{1,1}-F_{1,N}, F_{2,1}-F_{2,M}, and F_{3,1}-F_{3,K} are cascaded to thereby form the video frames F₁ to be processed by the recording apparatus 100/1300.

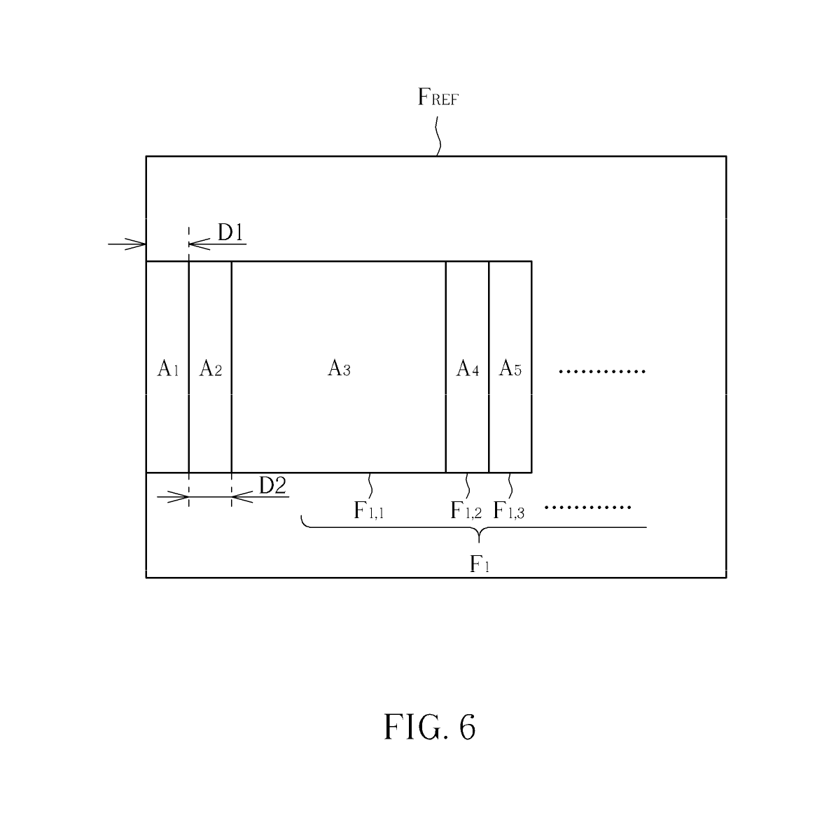

In another alternative design, the lower-resolution video frames F₁ (e.g., 640×480 video frames) may be derived from a high-resolution video frame (e.g., a 1920×1080 video frame). Please refer to FIG. 6, which is a diagram illustrating another exemplary arrangement of the video frames F₁ to be processed by the recording apparatus 100/1300. As shown in FIG. 6, the image resolution of a reference video frame F_{REF} is higher than the image resolution of each of the video frames F₁ including F_{1,1}, F_{1,2}, F_{1,3}, etc. The video frame F_{1,1} cropped from the reference video frame F_{REF} includes image regions A₁, A₂, and A₃; the video frame F_{1,2} cropped derived from the reference video frame F_{REF} includes image regions A₂, A₃, and A₄; and the video frame F_{1,3} cropped from the reference video frame F_{REF} includes image regions A₃, A₄, and A₅. In other words, the next video frame is shifted rightwards from the current video frame by D1/D2 pixels, where each of D1 and D2 may be any positive integer, and D1 may be equal to or different from D2. The positions (i.e., coordinates) of the video frames F_{1,1}-F_{1,3} in the reference video frame F_{REF} may be recorded as the associated image registration information.

Regarding the recording apparatuses 200 and 1400 shown in FIG. 2 and FIG. 4 respectively, the information acquisition circuits 204 and 1404 record image registration information INF₁-INF_{N} of the video frames F₁-F_{N} generated from respective lens 212_1-212_N. Considering a special case where the image capturing apparatus 201/1401 only has two lens used for generating one left-eye video frame (e.g., F₁) and one right-eye video frame (e.g., F₂). As the playback operation may only use one image registration information for selecting a pair of the left-eye video frame and the right-eye video frame, the information acquisition circuit 204/1404 may be configured to merely use the image registration information (e.g., INF₁/INF₂) of one of video frames F₁ and F₂ as recorded image registration information added to the video stream, or use an average of the image registration information INF₁ and INF₂ of video frames F₁ and F₂ as recorded image registration information added to the video stream.

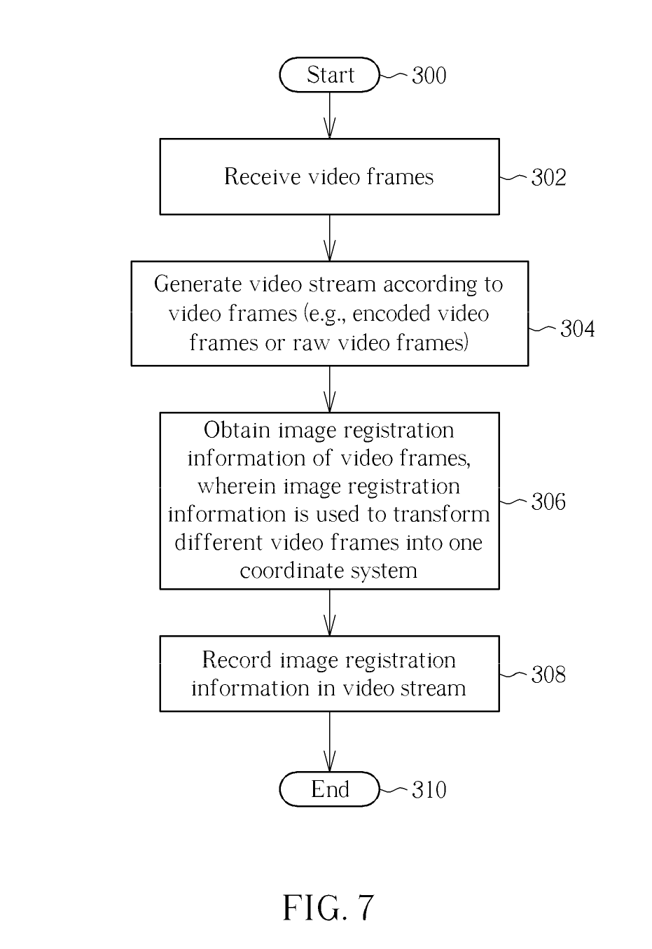

FIG. 7 is a flowchart illustrating a method for recording a plurality of video frames according to an exemplary embodiment. If the result is substantially the same, the steps are not required to be executed in the exact order shown in FIG. 7. The method is employed by the recording apparatus 100/200/1300/1400, and may be briefly summarized as follows.

Step 300: Start.

Step 302: Receive video frames. For example, the video frames may be directly generated from an image capturing apparatus which is moving/rotating in a desired direction, or may be obtained by other feasible means.

Step 304: Generate a video stream according to the video frames. For example, the video frames are encoded as the video stream or directly outputted as the video stream.

Step 306: Obtain image registration information of the video frames, wherein the image registration information is used to transform different video frames into one coordinate system.

Step 308: Record the image registration information in the video stream.

Step 310: End.

As a person skilled in the art can readily understand details of each step in FIG. 7 after reading above paragraphs directed to the recording apparatus 100/200/1300/1400, further description is omitted here for brevity.

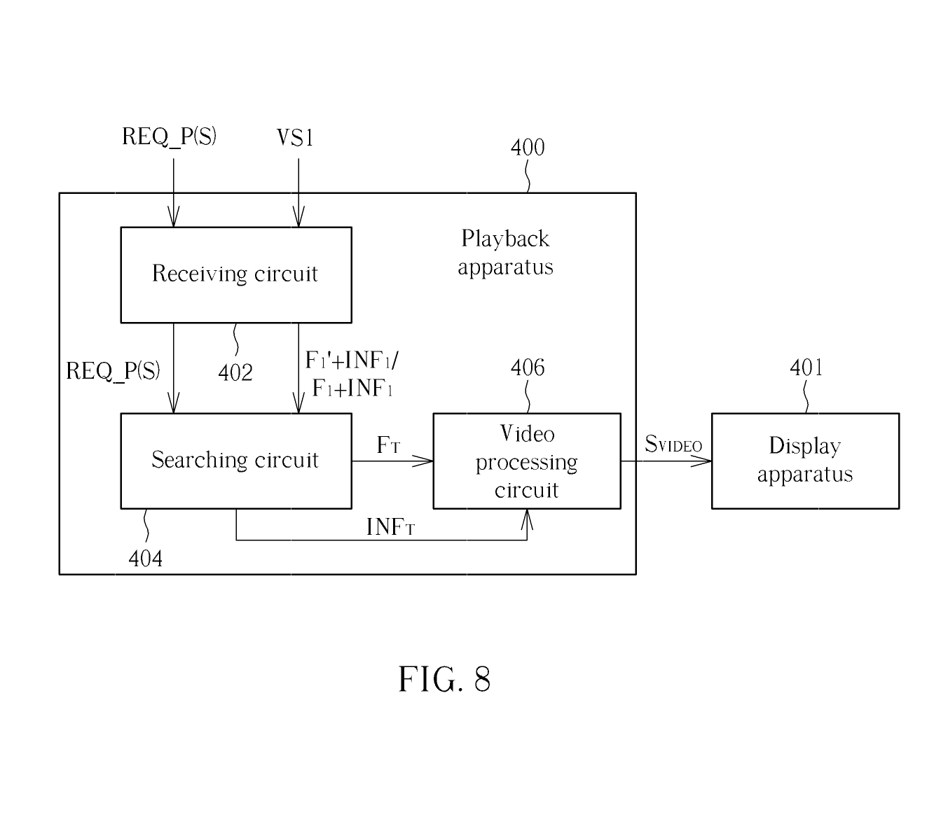

The image registration information serves as index values of video frames included in the video stream for indicating which video frames should be grouped as one video clip to be processed by a following procedure (e.g., a playback operation). Therefore, the user may view one video clip (i.e., video content of a selected scene within a panoramic video) that is associated with a selected viewing angle determined by user interaction. Please refer to FIG. 8, which is a diagram illustrating a playback apparatus according to an exemplary embodiment of the present invention. The exemplary playback apparatus 400 includes, but is not limited to, a receiving circuit 402, a searching circuit 404, and a video processing circuit 406. The receiving circuit 402 is arranged for receiving a playback request REQ_P for a selected scene S, and is also arranged for receiving a video stream VS1. In one exemplary embodiment, the video stream VS1 is consisted of the aforementioned image registration information INF₁ and encoded video frames F₁′, or is consisted of the aforementioned image registration information INF₁ and the raw video frames F₁. Alternatively, the video stream VS1 may be consisted of the aforementioned image registration information INF₁-INF_{N} and encoded video frames F₁′-F_{N}′, or may be consisted of the aforementioned image registration information INF₁-INF_{N} and the raw video frames F₁-F_{N}. Hence, the searching circuit 404 obtains a plurality of video frames (i.e., encoded video frames F₁′ or raw video frames F₁) and associated image registration information INF₁ from the receiving circuit 402. As the image registration information INF₁ is added to the video stream VS1 by the recording apparatus 100/200/1300/1400, the playback apparatus 400 obtains the image registration information INF₁ when receiving the video stream VS1. However, this is not meant to be a limitation of the present invention. In another exemplary embodiment, the video stream VS1 is only consisted of the aforementioned encoded video frames/raw video frames, where the encoded video streams/raw video frames and the associated image registration information are transmitted, separately.

The searching circuit 404 is coupled to the receiving circuit 402, and arranged for searching the video stream VS1 (e.g., encoded video frames F₁′/raw video frames F₁) for target video frames FT corresponding to image registration information of the selected scene S as indicated by the playback request REQ_P. The video processing circuit 406 is coupled to the searching circuit 404 and a display apparatus 401 (e.g., a display screen of a mobile phone or digital camera), and arranged for performing a playback operation according to the target video frames F_{T}. For example, when the target video frames F_{T} are encoded video frames, the playback operation would decode the target video frames F_{T} to generate corresponding decoded video frames, and generate a video output signal S_{VIDEO} to the display apparatus 401 according to the decoded video frames. In this way, the video information derived from the target video frames F_{T} is transmitted to the display apparatus 401 for playback. It should be note that the video processing circuit 406 does not decode all of the encoded video frames F₁′ for panoramic video playback, and only the target video frames F_{T} indexed by the image registration information of the selected scene S are selected and decoded, thus reducing the computational complexity. Alternatively, when the target video frames F_{T} are raw video frames, the playback operation would directly refer to the target video frames F_{T} to generate the video output signal S_{VIDEO} to the display apparatus 401. In this way, the video information derived from the target video frames F_{T} is transmitted to the display apparatus 401 for playback. Similarly, the video processing circuit 406 does not process all of the raw video frames F₁ for panoramic video playback, and only the target video frames F_{T} indexed by the image registration information of the selected scene S are selected and processed, thus reducing the computational complexity.

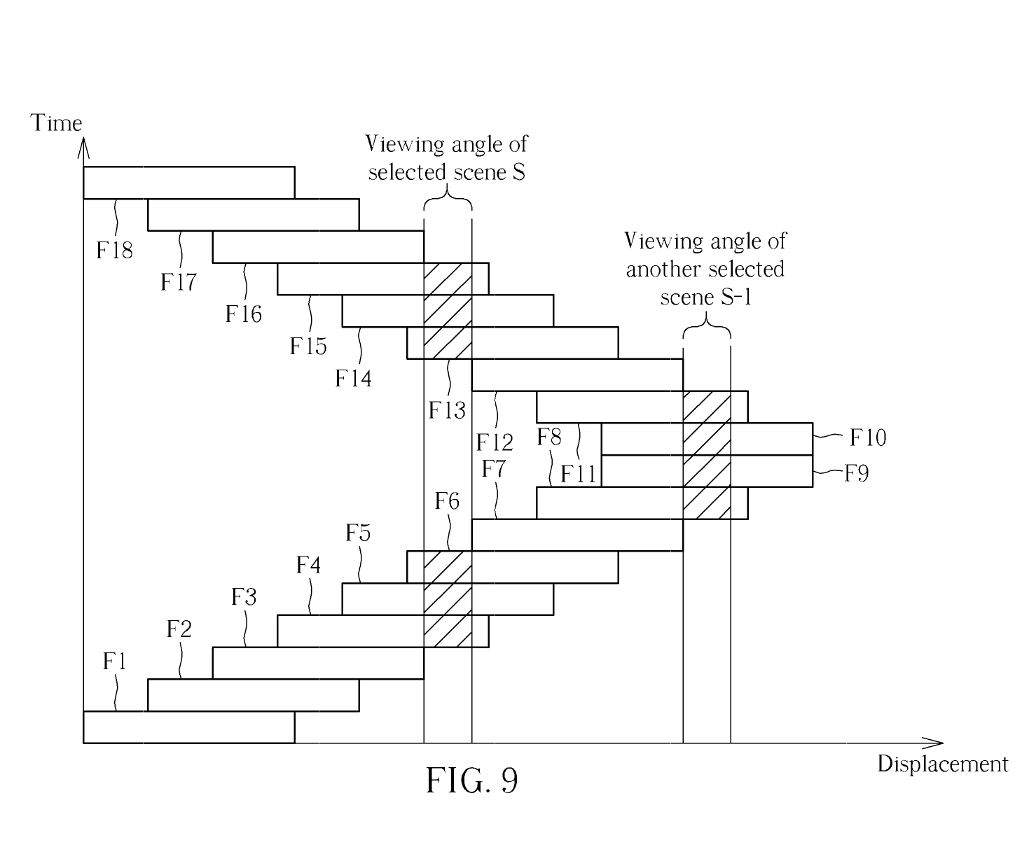

Please refer to FIG. 9, which is a diagram illustrating an exemplary video frame selection based on the playback request. Assuming that the user horizontally moves/pans the image capturing apparatus 101/201/1301/1401 from left to right and then from right to left, a plurality of video frames F1-F18 are sequentially captured via one lens. Assume that the playback request REQ_P indicates that the user desires to view the selected scene S (e.g., the video content of a selected viewing angle with respect to the image capturing apparatus 101/201/1301/1401). As shown in FIG. 9, the video frames F4-F6 and F13-F15 include information of the selected scene S. Based on the image registration information of each of the video frames F1-F18, the video frames F4-F6 and F13-F15 would be selected due to the fact that respective image registration information corresponds to the selected scene S.

Next, the video processing circuit 406 refers to the selected video frames F4-F6 and F13-F15 for controlling the display apparatus 401 to display the video content of the selected scene S (i.e., video segments as indicated by shaded areas in FIG. 9). As the video frames F4-F6 and F13-F15 are recorded at different time points, repeating the playback operation of the video segments sequentially selected from the video frames F4-F6 and F13-F15 may result in a discontinuous infinite video. To mitigate the discontinuity perceived by the viewer when an infinite video of the same viewing angle is displayed according to a repeat playback scheme, a cross-fade effect may be introduced between the transition between the video segment selected from the video frame F15 and the video segment selected from the video frame F4. In addition, adjusting the repeat order of the video segments selected from the video frames F4-F6 and F13-F15 may be capable of mitigating the discontinuity perceived by the viewer. For example, a reverse playback scheme may be employed such that the video segments sequentially selected from the video frames F4-F6 and F13-F15 in a normal order are displayed, and then the video segments sequentially selected from the video frames F15-F13 and F6-F4 in a reverse order are displayed.

The viewer is allowed to navigate any scene within the panoramic video. For example, when the playback request REQ_P indicates that the user desires to view another selected scene S-1 , the video frames F8-F11 including information of the selected scene S-1 are selected according to the image registration information of the video frames F8-F11. Next, the video processing circuit 406 refers to the selected video frames F8-F11 for controlling the display apparatus 401 to display the video content of the selected scene S-1 (i.e., video segments as indicated by shaded areas in FIG. 9)

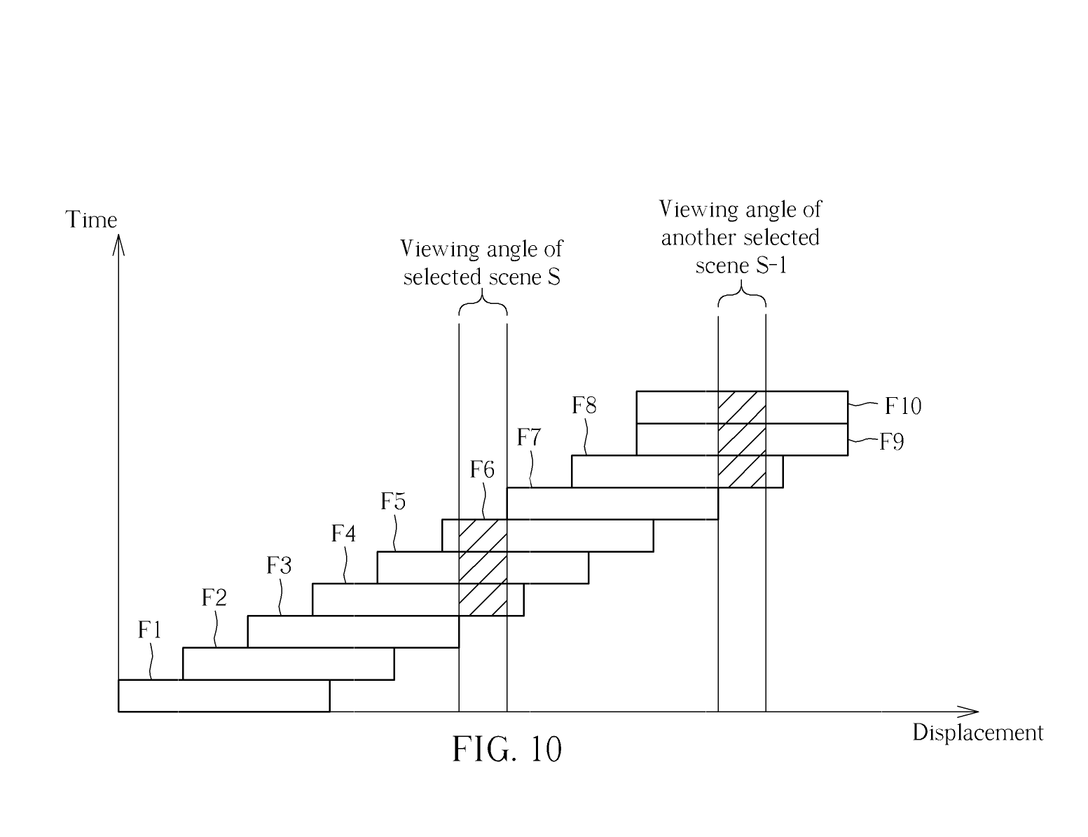

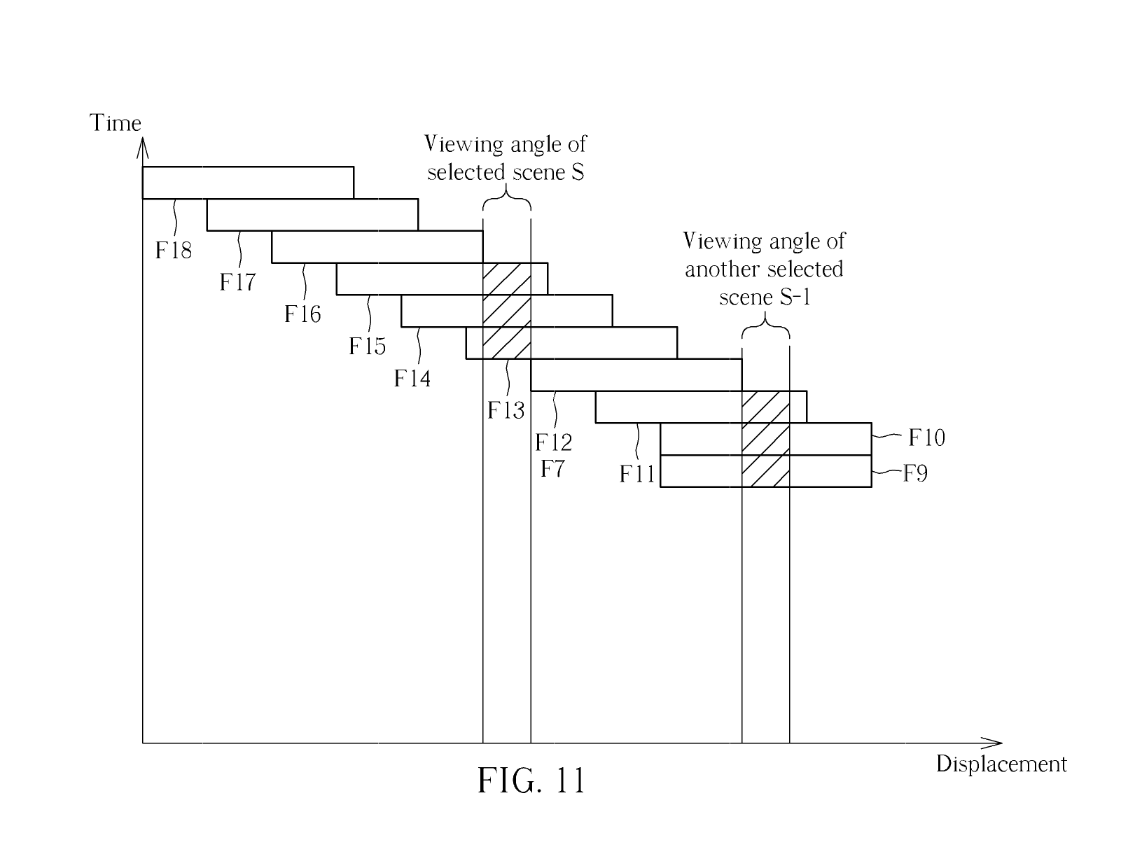

In the example shown in FIG. 9, the scene selection and playback operation is applied to a panoramic video including video frames F1-F18 sequentially generated by horizontally moving/panning the image capturing apparatus 101/201/1301/1401 from left to right and then from right to left. However, as shown in FIG. 10, the proposed scene selection and playback operation may also be applied to a panoramic video only including video frames F1-F10 sequentially generated by horizontally moving/panning the image capturing apparatus 101/201/1301/1401 in one direction (e.g., from left to right). Further, as shown in FIG. 11, the proposed scene selection and playback operation may also be applied to another panoramic video only including video frames F9-F18 sequentially generated by horizontally moving/panning the image capturing apparatus 101/201/1301/1401 in one direction (e.g., from right to left).

In addition to controlling playback of an infinite video, the video processing circuit 406 may perform one or more image processing operations according to the target video frames F_{T} selected by the preceding searching circuit 404. For example, the video processing circuit 406 performs an alignment operation upon decoded video frames/raw video frames derived from the target video frames F_{T} according to associated image registration information INF_{T}, and accordingly generates aligned video frames. Hence, the playback operation generates the video output signal S_{VIDEO} to the display apparatus 401 according to the aligned video frames. By way of example, but not limitation, the alignment operation includes video capturing condition normalization, viewing frame size normalization, and/or frame alignment process.

When the image registration information INF_{T} of the target video frames F_{T} includes camera capture condition information such as focus information, white balance information and/or expose information, the video processing circuit 406 performs video capturing condition normalization upon decoded video frames/raw video frames of the target video frames F_{T} according to the camera capturing condition information of the target video frames F_{T}. In this way, focus normalization, exposure normalization and/or white balance normalization are performed upon the decoded video frames/raw video frames of the target video frames F_{T} to remove/minimize the camera capture condition discrepancy.

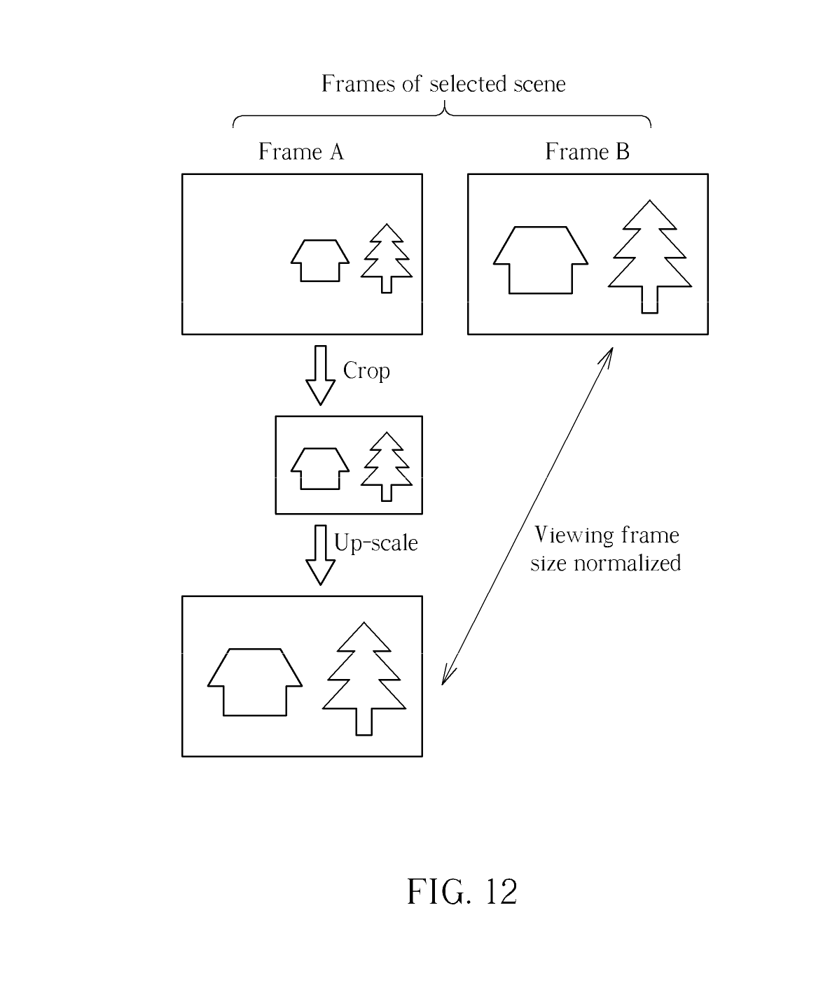

When the image registration information INF_{T} of the target video frames F_{T} includes translate information, rotation information and/or scale information, the video processing circuit 406 performs the viewing frame size normalization upon decoded video frames/raw video frames of the target video frames F_{T} according to at least one of translate information, rotation information, and scale information of the target video frames F_{T}. For example, the viewing frame size normalization may crop at least one of the decoded video frames/raw video frames of the target video frames F_{T} to generate a cropped video frame, wherein the original video frame has a first resolution, and the cropped video frame has a second resolution lower than the first resolution. Besides, as shown in FIG. 12, the cropped video frame may be up-scaled if needed.

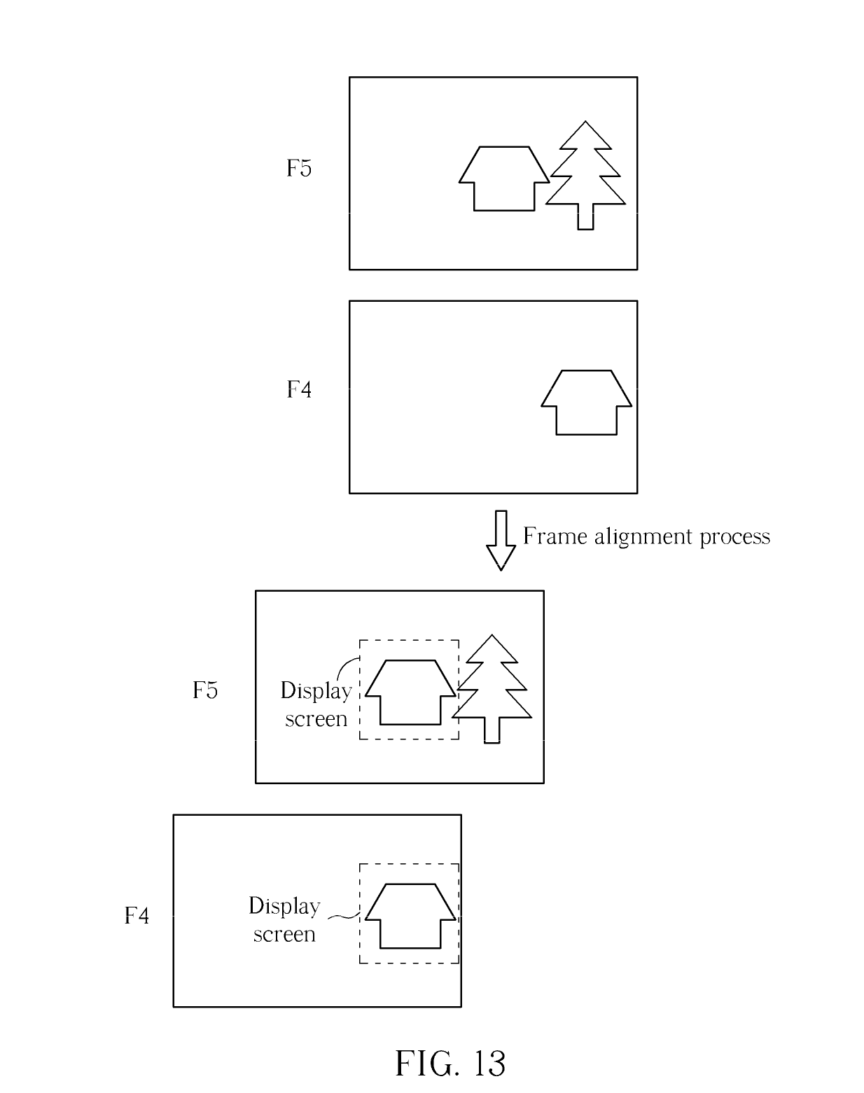

The frame alignment process performed by the video processing circuit 406 may be used to align frames by feature point matching and/or image warping. Alternatively, when global motion information is recorded in the image registration information INF_{T}, the frame alignment process performed by the video processing circuit 406 may be used to align frames by referring to the global motion information. Please refer to FIG. 13, which is a diagram illustrating an example of the frame alignment process. Taking the video frames F4 and F5 shown in FIG. 9 for example, the video frames F4 and F5 have one common object (e.g., a house) located at different positions due to movement of the image capturing apparatus 101/201/1301/1401. After the frame alignment process is performed, the common object in the video frame F4 is aligned with the same common object in the video frame F5. It should be noted that, regarding each of the video frames F4 and F5, only the cropped video segment corresponding to the viewing angle of the selected scene would be shown in the display screen.

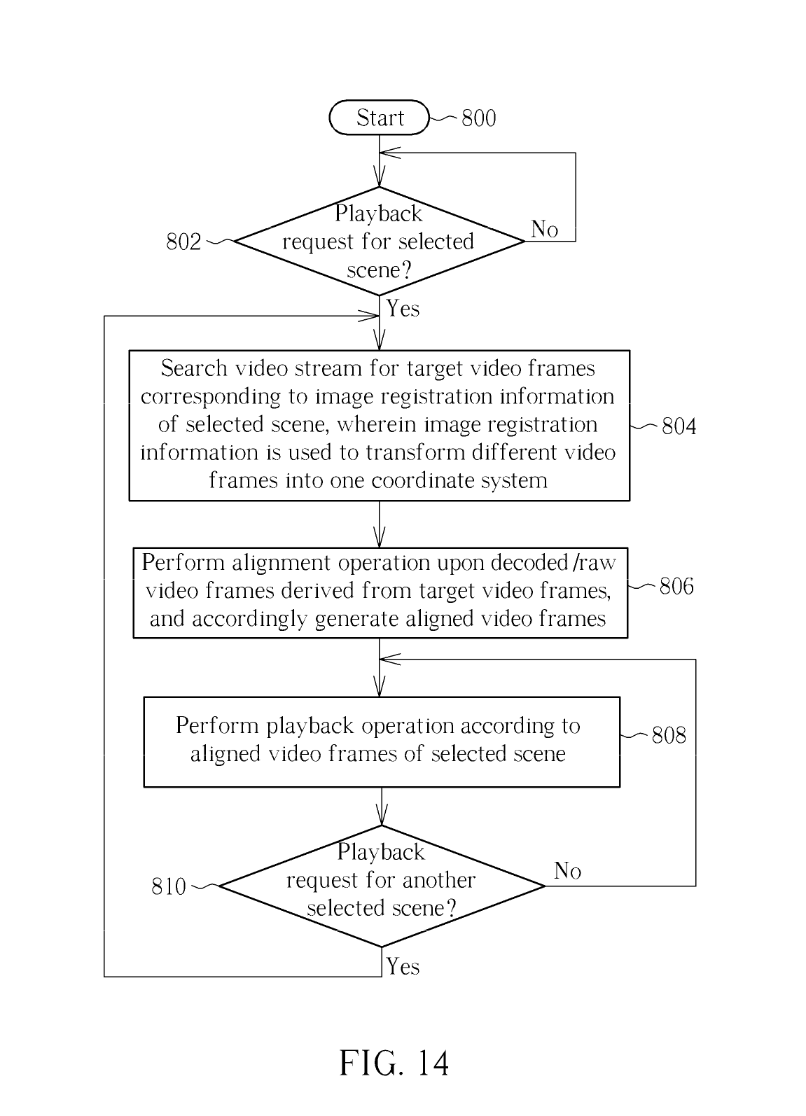

FIG. 14 is a flowchart illustrating a playback method of a video stream according to an exemplary embodiment. If the result is substantially the same, the steps are not required to be executed in the exact order shown in FIG. 14. The method is employed by the playback apparatus 400, and may be briefly summarized as follows.

Step 800: Start.

Step 802: Check if a playback request for a selected scene is received. If yes, go to step 804; otherwise, execute step 802 to keep monitoring reception of the playback request.

Step 804: Search the video stream for target video frames (e.g., encoded video frames or raw video frames) corresponding to image registration information of the selected scene, wherein the image registration information is used to transform different video frames into one coordinate system.

Step 806: Perform an alignment operation upon decoded video frames/raw video frames derived from the target video frames, and accordingly generate aligned video frames. For example, the alignment operation may include video capturing condition normalization, viewing frame size normalization and/or frame alignment process.

Step 808: Perform a playback operation according to the aligned video frames of the selected scene.

Step 810: Check if a playback request for another selected scene is received. If yes, go to step 804; otherwise, go to step 808 to keep performing the playback operation for the selected scene.

As a person skilled in the art can readily understand details of each step in FIG. 14 after reading above paragraphs directed to the playback apparatus 400, further description is omitted here for brevity.

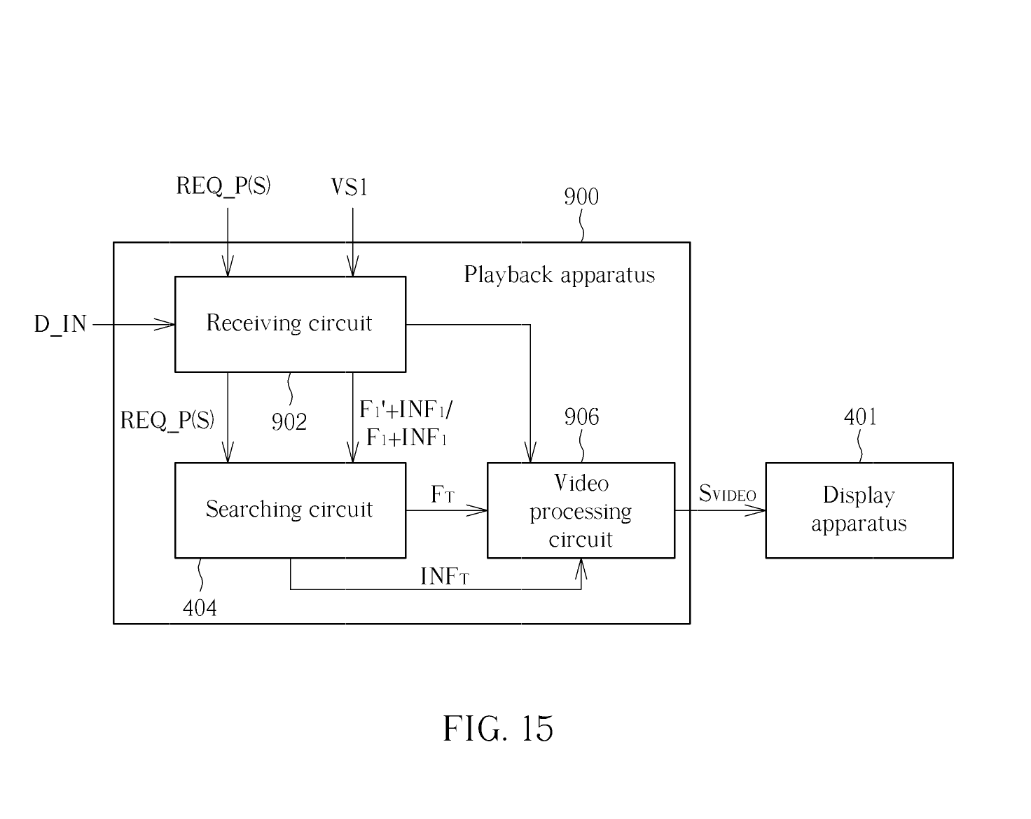

In addition to the alignment operation, the video processing circuit 406 may perform other image processing operation(s) upon decoded video frames/raw video frames derived from the target video frames F_{T}. Please refer to FIG. 15, which is a diagram illustrating a playback apparatus according to another exemplary embodiment of the present invention. The operation of the receiving circuit 902 is almost the same as that of the receiving circuit 402, and the operation of the video processing circuit 906 is almost the same as that of the video processing circuit 406. The major difference between the playback apparatuses 400 and 900 is that the receiving circuit 902 further receives graphic data DIN, and the video processing circuit 906 further processes decoded video frames/raw video frames derived from the target video frames F_{T} according to the graphic data D_IN. By way of example, but not limitation, the graphic data D_IN is user interface (UI) data, and the video processing circuit 906 is arranged to overlay the graphic data D_IN with decoded video frames/raw video frames (e.g., aligned video frames) derived from the target video frames F_{T} to generate mixed video frames, and performing the playback operation for the selected scene according to the mixed video frames. In this embodiment, the video processing circuit 906 transmits the mixed video frames to the display apparatus 401 via the video output signal S_{VIDEO} such that video contents of the selected scene and the graphic data D_IN are displayed on the display apparatus 401.

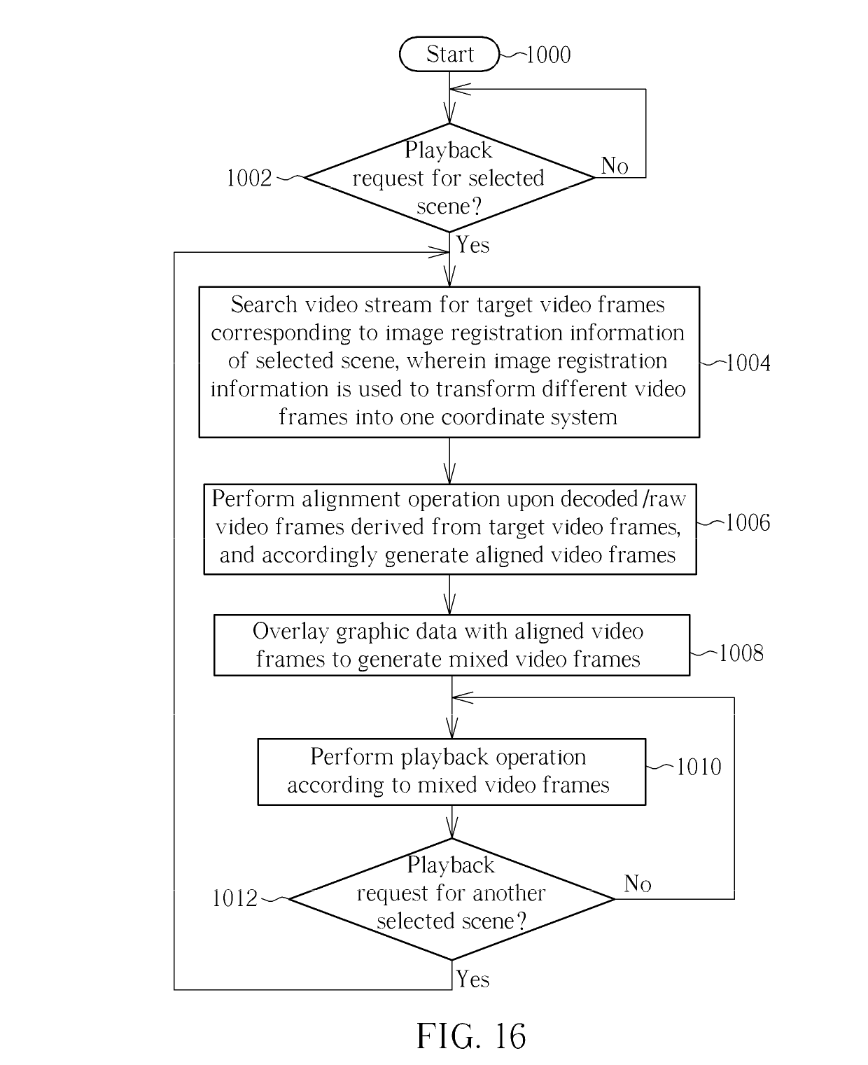

FIG. 16 is a flowchart illustrating a playback method of a video stream according to another exemplary embodiment. If the result is substantially the same, the steps are not required to be executed in the exact order shown in FIG. 16. The method is employed by the playback apparatus 900, and may be briefly summarized as follows.

Step 1000: Start.

Step 1002: Check if a playback request for a selected scene is received. If yes, go to step 1004; otherwise, execute step 1002 to keep monitoring reception of the playback request.

Step 1004: Search the video stream for target video frames (e.g., encoded video frames or raw video frames) corresponding to image registration information of the selected scene, wherein the image registration information is used to transform different video frames into one coordinate system.

Step 1006: Perform an alignment operation upon decoded video frames/raw video frames derived from the target video frames, and accordingly generate aligned video frames. For example, the alignment operation may include video capturing condition normalization, viewing frame size normalization and/or frame alignment process.

Step 1008: Overlay graphic data with the aligned video frames to generate mixed video frames.

Step 1010: Perform a playback operation according to the mixed video frames of the selected scene.

Step 1012: Check if a playback request for another selected scene is received. If yes, go to step 1004; otherwise, go to step 1010 to keep performing the playback operation for the selected scene.

As a person skilled in the art can readily understand details of each step in FIG. 16 after reading above paragraphs, further description is omitted here for brevity.

In the embodiment shown in FIG. 15, the overlay operation is performed by the playback apparatus 900. In an alternative design, the overlay operation may be performed by the display apparatus 401. For example, the playback apparatus 400 shown in FIG. 8 generates decoded video frames/raw video frames (e.g., aligned video frames) derived from the target video frames F_{T} to the display apparatus 401 via the video output signal S_{VIDEO}. Next, the display apparatus 401 overlays the graphic data D_IN with the received video frames to generate mixed video frames, and then performs the playback operation for the selected scene by displaying the mixed video frames.

For better understanding of the aforementioned scene selection and playback operation performed in response to user interaction, an implementation example is described as below. Suppose that the image registration information includes 2D coordinate of each video frame. Thus, based on the 2D coordinate of each video frame, the user can change viewing angle to thereby navigate video frames across a panoramic 2D space. When stopping at a navigational viewing angle, the user will view the consecutive aligned video frames after cropping. Specifically, when the user selects a new horizontal viewing angle to navigate, the system will find a video frame with minimal distance in X-axis:

Dist=Min|P−Xᵢ| (2)

where P is the accumulated moving pixel from the user input, Xᵢ is the X coordinate of frame i, and Dist is the minimal distance from P among all video frames. The video frame with the Dist value is selected to display. To align the output frame with the consecutive video frames when the user stops at a viewing angle, the frames need to be cropped before displayed. Specifically, the alignment is based on the (x, y) coordinate of each video frame from the recording stage. Therefore, only overlapped region of the consecutive video frames can be displayed. So, the video frames need to be cropped according to the coordinate values thereof. In the Y-axis, the cropping is based on the relative coordinate in global space. In the X-axis, the cropping region is based on the relative coordinate values between the current display frame FB and the first frame of the consecutive video frames FA:

Crop=Initₓ+FBₓ −FAₓ (3)

where Cropₓ is the cropped pixel in X-axis of FB, FAₓ is the X coordinate of FA, FBₓ is the X coordinate of FB, and Initₓ is the cropped pixel in X-axis of FA. The Initₓ may be defined as:

Initₓ=0, if C=0, (4)

Initₓ=F_{w}−O_{w}, if C=1 (5)

where F_{w} is the width of input video frame, O_{w} is the output cropped width, and C is the camera panning/moving direction. The X coordinate difference between the last frame and the first frame of entire video is used as the camera panning/moving direction. Therefore, the above C value is equal to 1 if the camera pans/moves right, and is equal to 0 if the camera pans/moves left.

The consecutive video frames of a given viewing angle is defined as that the frames are consecutive and satisfy the following condition:

FBₓ−FAₓ<F_{w}−O_{w} (6)

That is, the consecutive frames for FA are the frames overlapped with the cropped region of FA. The number of the consecutive video frames can also be controlled by O_{w}. In other words, the output field-of view can be reduced to correspondingly increase the time of the consecutive video frames. For example, the value of O_{w} is 0.8×F_{w}˜0.9×F_{w}, which is also dependent on the cropped pixel in Y-axis for keeping the output aspect ratio.

In contrast to the conventional system which needs to decode a wide-filed video frame and crop and warp a selected region according to user interaction, the proposed panoramic video system of the present invention does not need a large wide-filed buffer for video decoding, but uses a frame buffer with original captured size for video decoding (if video decoding is performed in the video viewing stage). Besides, the time-consuming image warping operation is not needed by the proposed panoramic video system, either. The original input video is usually well calibrated without any distortion when captured. So, the panorama image quality in the proposed panoramic video system is guaranteed without any ghosting and image distortion that is generally present in the conventional stitched video panorama.

As mentioned above, the image processing operations, including alignment operation, cropping operation, normalization operation, etc., are performed by the processing circuit 406/906 implemented in the playback apparatus 400/900. Alternatively, the aforementioned image processing operations may be performed at the video processing circuit 102/202 of the recording apparatus 100/200/1300/1400 rather than the processing circuit 406/906 of the playback apparatus 400/900, such that the processing circuit 406 simply generates the video output signal S_{VIDEO} to the display apparatus 401 according to the video frames (e.g., decoded video frames or raw video frames) without performing any of the aforementioned image processing operations (e.g., alignment operation, cropping operation, and/or normalization operation).

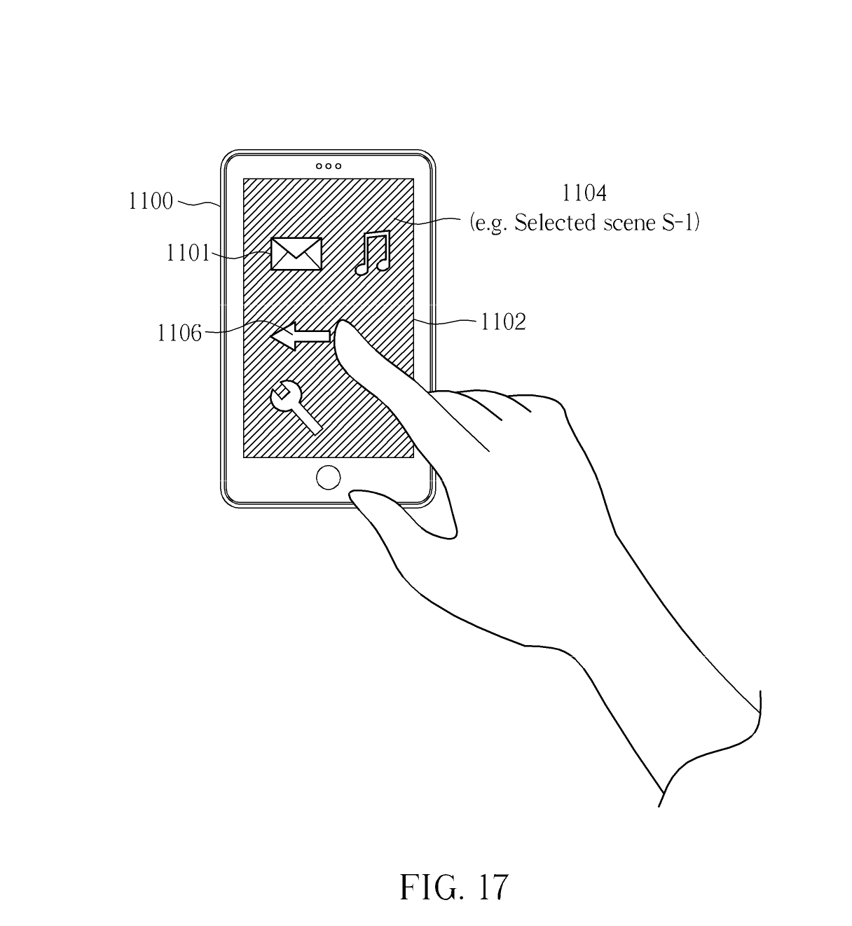

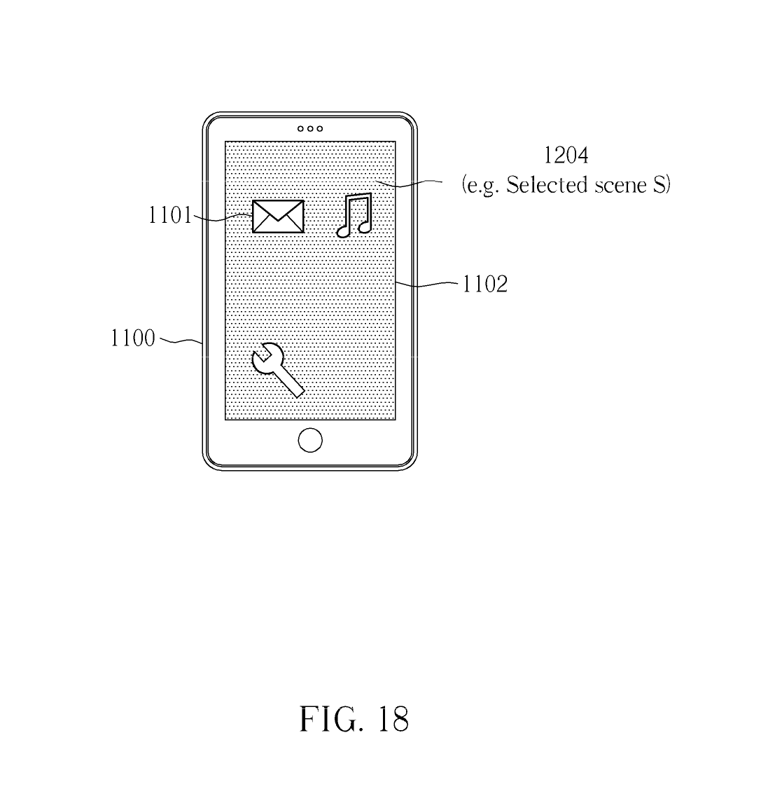

Moreover, the playback apparatus 400 shown in FIG. 8 may be employed for controlling a desktop of a user interface in an electronic device (e.g., a mobile phone). Please refer to FIG. 17 in conjunction with FIG. 18. FIG. 17 is a diagram illustrating one live wallpaper displayed in a display screen (e.g., a touch screen) 1102 of an electronic device 1100. FIG. 18 is a diagram illustrating another live wallpaper displayed in the display screen 1102 due to a desktop scrolling command. As shown in FIG. 17, the desktop uses an infinite video generated by displaying video segments corresponding to the viewing angle of the selected scene S-1 shown in FIG. 9 as a live wallpaper 1104, where some icons 1101 are overlaid on the live wallpaper 1104. When a desktop scrolling command 1106 is inputted by the user, for example, through moving his/her finger on the display screen 1102, a playback request REQ_P of another selected scene S is generated in response to the desktop scrolling command 1106. Therefore, as shown in FIG. 18, the desktop now uses an infinite video generated by displaying video segments corresponding to the viewing angle of the selected scene S shown in FIG. 9 as a live wallpaper 1204.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of processing a plurality of video frames, comprising:
obtaining image registration information of the video frames, wherein the image registration information is used to transform different video frames into one coordinate system; and
searching for a plurality of target video frames corresponding to a selected scene among the video frames by using the image registration information.

2. The method of claim 1, further comprising:
receiving a video stream having the video frames and the image registration information included therein;
wherein the step of obtaining the image registration information of the video frames comprises:
obtaining the image registration information of the video frames from the received video stream.

3. The method of claim 1, wherein the step of obtaining the image registration information comprises:
obtaining a scene number assigned to at least one video frame.

4. The method of claim 1, wherein the step of obtaining the image registration information comprises:
obtaining a coordinate assigned to at least one video frame.

5. The method of claim 4, wherein a coordinate assigned to a beginning video frame among the video frames is at an origin.

6. The method of claim 1, wherein the step of obtaining the image registration information comprises:
obtaining global motion information.

7. The method of claim 1, wherein the step of obtaining the image registration information comprises:
obtaining sensor information of at least one sensor disposed on an image capturing apparatus that generates the video frames.

8. The method of claim 1, wherein the step of obtaining the image registration information comprises:
obtaining at least one of translate information, rotation information, and scale information of at least one video frame.

9. The method of claim 1, wherein the step of obtaining the image registration information comprises:
obtaining camera capture condition information of at least one video frame.

10. The method of claim 9, wherein the camera capture condition information comprises at least one of focus information, white balance information, and expose information.

11. The method of claim 1, wherein the video frames form a plurality of video clips each having designated image registration information, and processing of the video frames uses one video clip as a unit.

12. A playback method of a video stream, comprising:
receiving a playback request for a selected scene;
searching the video stream for target video frames corresponding to image registration information of the selected scene, wherein the image registration information is used to transform different video frames into one coordinate system; and
performing a playback operation according to the target video frames found in the video stream.

13. The playback method of claim 12, wherein the step of performing the playback operation comprises:
performing an alignment operation upon video frames derived from the target video frames, and accordingly generating aligned video frames.

14. The playback method of claim 13, wherein the step of performing the playback operation further comprises:
performing the playback operation according to the aligned video frames.

15. The playback method of claim 13, wherein the step of performing the alignment operation upon the video frames derived from the target video frames comprises:
performing video capturing condition normalization upon the video frames according to camera capturing condition information of the target video frames.

16. The playback method of claim 15, wherein the camera capture condition information comprises at least one of focus information, white balance information, and expose information.

17. The playback method of claim 13, wherein the step of performing the alignment operation upon the video frames derived from the target video frames comprises:
performing viewing frame size normalization upon the video frames according to at least one of translate information, rotation information, and scale information of the target video frames.

18. The playback method of claim 17, wherein the viewing frame size normalization comprises:
cropping a video frame derived from a target video frame to generate a cropped video frame, wherein the video frame has a first resolution, and the cropped video frame has a second resolution lower than the first resolution.

19. The playback method of claim 12, wherein the playback request is generated in response to a desktop scrolling command, and the step of performing the playback operation comprises:
displaying a live wallpaper according to the target video frames.

20. The playback method of claim 12, wherein the step of performing the playback operation comprises:
generating mixed video frames by overlaying graphic data with video frames derived from the target video frames; and
performing the playback operation according to the mixed video frames.

21. The playback method of claim 19, wherein the graphic data is user interface (UI) data.

22. The playback method of claim 12, wherein the video stream transmits a plurality of video frames that form a plurality of video clips each having designated image registration information, and playback of the video stream uses one video clip as a unit.

23. An apparatus for recording a plurality of video frames, comprising:
a video processing circuit, arranged for generating a video stream according to the video frames; and
an information acquisition circuit, arranged for obtaining image registration information of the video frames, and recording the image registration information in the video stream, wherein the image registration information is used to transform different video frames into one coordinate system.

24. The apparatus of claim 23, wherein the information acquisition circuit assigns a scene number to at least one video frame to obtain the image registration information.

25. The apparatus of claim 23, wherein the information acquisition circuit assigns a coordinate to at least one video frame to obtain the image registration information.

26. The apparatus of claim 25, wherein a coordinate assigned to a beginning video frame among the video frames is at an origin.

27. The apparatus of claim 23, wherein the information acquisition circuit applies a global motion estimation upon adjacent video frames and accordingly generates global motion information to obtain the image registration information.

28. The apparatus of claim 23, wherein the information acquisition circuit obtains sensor information provided by at least one sensor disposed on an image capturing apparatus that generates the video frames to obtain the image registration information.

29. The apparatus of claim 23, wherein the information acquisition circuit obtains at least one of translate information, rotation information, and scale information of at least one video frame to obtain the image registration information.

30. The apparatus of claim 23, wherein the information acquisition circuit obtains camera capture condition information of at least one video frame to obtain the image registration information.

31. The apparatus of claim 30, wherein the camera capture condition information comprises at least one of focus information, white balance information, and expose information.
